(19) United States
(12) Patent Application Publication
(10) Pub. No.: US 2015/0375145 A1
(43) Pub. Date: Dec. 31, 2015

(54) DUAL PASS STACKED SHAKERS AND METHOD FOR USING SAME

(71) Applicant: M-I L.L.C., Houston, TX (US)

(72) Inventor: Joe Sherwood, Houston, TX (US)

(21) Appl. No.: 14/769,740

(22) PCT Filed: Feb. 21, 2014
(86) PCT No.: PCT/US2014/017769

§ 371 Date: Aug. 21, 2015

Related U.S. Application Data
(60) Provisional application No. 61/767,575, filed on Feb. 21, 2013.

(51) Int. Cl. B01D 33/03; B01D 33/41

(52) U.S. Cl. CPC B01D 33/0361; B01D 33/41

(57) ABSTRACT

A dual pass shaker system and method has a first line of shakers and a second line of shakers. The first line may be parallel shakers, and the second line may be series shakers or a combination of each. Arranging the shakers above each other conserves space. The shaker system maximizes screen area exposure from the dual pass system over and/or through the stacked design of the shakers. The system allows customizing the flow of the slurry through the shakers via valves and a distribution manifold to maximize the number of screens over which the slurry flows. The slurry flows through any configuration of shakers desired.

### BACKGROUND

In certain industries and/or applications, separating one material from a second material is often desired and/or required. Further, the separation of solids and fluids is generally known in a variety of industries and/or applications. For example, the mining industry has many applications in which solids may be separated from fluids to extract a desired ore and/or metal during mining processes. Further, on-shore and/or off-shore drilling applications use various methods and/or equipment to separate solids from fluids in drilling processes.

For example, drilling fluids or muds are commonly circulated in the well during such drilling to cool and lubricate the drilling apparatus, lift drilling cuttings out of the wellbore, and counterbalance the subterranean formation pressure encountered. The recirculation of the drilling mud requires the fast and efficient removal of the drilling cuttings and other entrained solids from the drilling mud prior to reuse.

Apparatus to remove cuttings and other solid particulates from drilling fluid are commonly referred to as “shale shakers.” A shale shaker, also known as a vibratory separator, is a vibrating sieve-like table upon which returning solids laden drilling fluid is deposited and through which clean drilling fluid emerges. Typically, the shale shaker is an angled table with a generally perforated filter screen bottom. Returning drilling fluid is deposited at the feed end of the shale shaker. As the drilling fluid travels down the length of the vibrating table, the fluid falls through the perforations to a reservoir below leaving the solid particulate material behind. The vibrating action of the shale shaker table conveys solid particles left behind until they fall off the discharge end of the shaker table. In other shale shakers, the top edge of the shaker is relatively closer to the ground than the lower end. In such shale shakers, the angle of inclination may require the movement of particulates in a generally upward direction. In still other shale shakers, the table may not be angled, thus the vibrating action of the shaker alone may enable particle/fluid separation. Regardless, table inclination and/or design variations of existing shale shakers should not be considered a limitation of the disclosure.

### BRIEF DESCRIPTION OF DRAWINGS

FIG. 1 is a perspective view of a stacked shaker layout in accordance with embodiments disclosed herein.

FIG. 2 is a cross-sectional view in perspective of a parallel model shaker in accordance with embodiments disclosed herein.

FIG. 3 is a cross-sectional view in perspective of a series model shaker in accordance with embodiments disclosed herein.

FIG. 4 is a diagram of a stacked shaker layout implemented in upper hole sections in accordance with embodiments disclosed herein.

FIG. 5 is a diagram of a stacked shaker layout in deeper hole sections in accordance with embodiments disclosed herein.

### DETAILED DESCRIPTION

Generally, embodiments disclosed herein relate to apparatuses and methods for separating a first material from a second material, for example, for separating solids from fluids. In particular, embodiments disclosed herein relate to apparatuses and methods for stacking shakers to be used in conjunction with systems and methods for drilling boreholes. Further, apparatuses and methods disclosed herein may have two types of shakers that may be stacked and/or implemented for use within the same area. Moreover, apparatuses and methods disclosed herein may have multiple shakers configured to control flow between different combinations of shakers as desired. Furthermore, apparatuses and methods disclosed herein may have multiple shakers of different types configured and/or arranged to allow real-time adjustments to the flow of the materials to be separated.

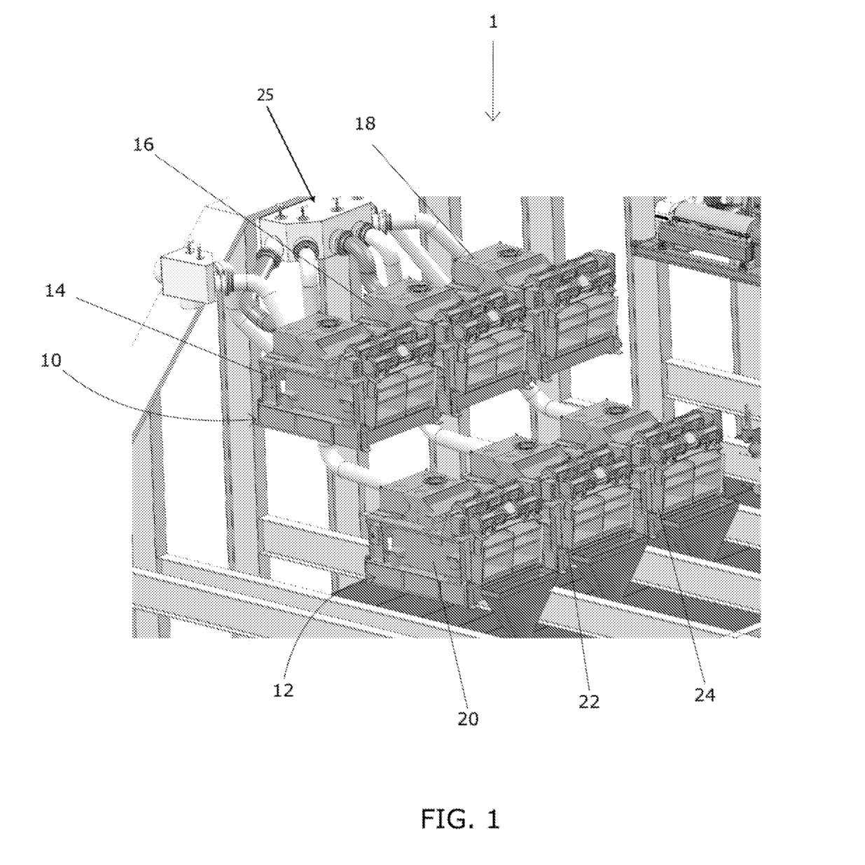

Referring to FIG. 1, a perspective view of a plurality of stacked shakers forming a shaker system 1 are shown. The stacked shakers have at least a first line 10 and a second line 12. In an embodiment, the first line 10 may be three parallel shakers 14, 16, 18 that may be arranged and operatively connected and/or arranged with respect to three series shakers 20, 22, 24. The parallel shakers 12, 14, 16 may be configured to be used in conjunction with the series shakers 20, 22, 24, respectively. Although three parallel shakers 12, 14, 16 and three series shakers 20, 22, 24 are shown and described with reference to FIG. 1, it should be understood that the number of shakers may be varied and/or configured as desired for a particular shaker system 1 and/or application. The shaker system 1 may be customized as desired.

The shaker system 1 may have a distribution manifold 25. The distribution manifold 25 may be configured to direct and/or control the flow of the slurry through the shaker system 1. The distribution manifold 25 may have header boxes, multiple pipes with corresponding valves, flow controllers, monitors and/or the like to control and/or regulate the flow of the slurry in the shaker system 1. The shaker system 1 may be configured to receive and process multiple slurries simultaneously. The multiple slurries may originate from different wellbores. The shaker system 1 may monitor the levels and/or loads of the slurry in each of the shakers to assist in determining the overall efficiency of the shaker system 1 and may allow adjustments and/or changes to maximize performance of the shaker system 1.

For example, embodiments of the shaker system 1 may be configured to operate all of the parallel shakers 12, 14, 16 and all of the series shakers 20, 22, 24, simultaneously. Other embodiments of the shaker system 1 may be configured to operate one level of the shakers, for example, the parallel shakers 12, 14, 16 or the other level of the shakers, for example, the series shakers 20, 22, 24. Yet further embodiments of the shaker system 1 may be configured to operate only a pair of shakers, one from each level, for example, the parallel shaker 12 and the series shaker 20. The shaker system 1 may be configured to direct the slurry to the desired number and/or type of shakers. All combinations of the parallel shakers 12, 14, 16 and/or the series shakers 20, 22, 24 may be possible. This resultant dual pass stacked shaker arrangement may offer maximum screen area exposure by both types of shakers in any single pass.

The shaker system 1 may also be configured to bypass certain shakers and/or bypass the slurry to other separation equipment, different locations and/or the like. Thus, the shaker system 1 may provide the flexibility to switch between different configurations for the flow of the slurry in which certain shakers of different types may be used or bypassed as desired to attain the separation of fluids and solids desired in various applications.

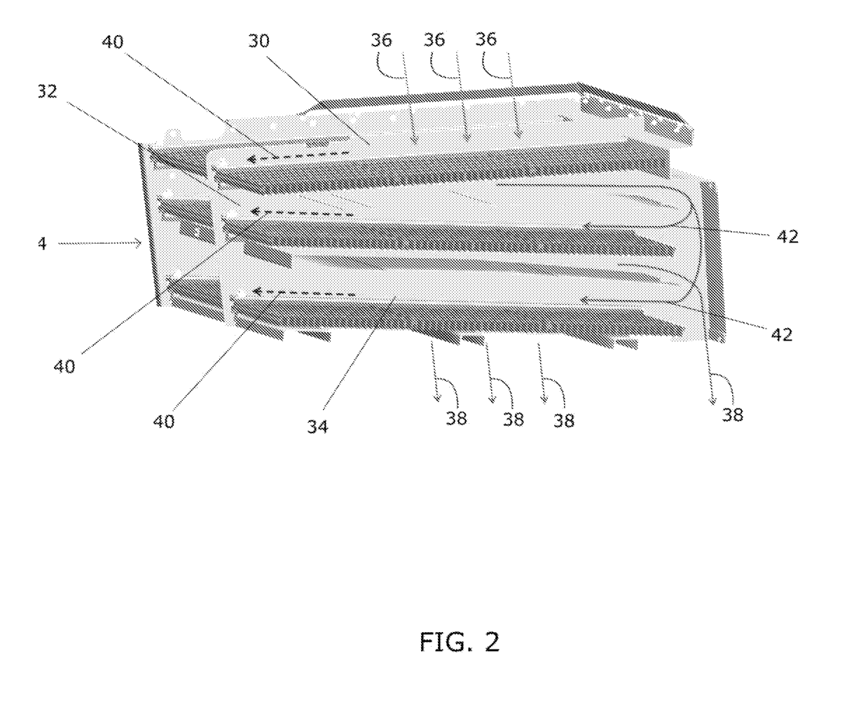

As shown in FIG. 2, a perspective cross-sectional view of one parallel shaker 14 is generally shown. Each of the parallel shakers 14, 16, 18 may be substantially identical to that shown and described with reference to the description of the parallel shaker 14 shown in FIG. 2. In an embodiment, the parallel shaker 14 or a plurality of parallel shakers make up the first line 10. The parallel shaker 14 has a primary scalping deck 30 that receives the entirety of the flow of the parallel shaker 14. The flow may be divided in half with approximately one-half of the flow received by a sub-level 32, and the other half received by a sub-level 34.

Incoming fluid to the parallel shaker 14 is designated by the arrows 36 at the top portion of the parallel shaker 14 with the primary effluents directed to a skid as generally shown by the arrows 38. Solids may be discarded from the parallel shaker 14 as generally designated by the arrows 40, and the scalping effluent to each of the sub-levels 32 is generally designated by the arrows 42. As a result of the configuration of the parallel shaker 14, the primary scalping deck 30 receives the entirety of the flow with the sub-levels 32, 34 each receiving about one-half of the flow from the primary scalping deck 30.

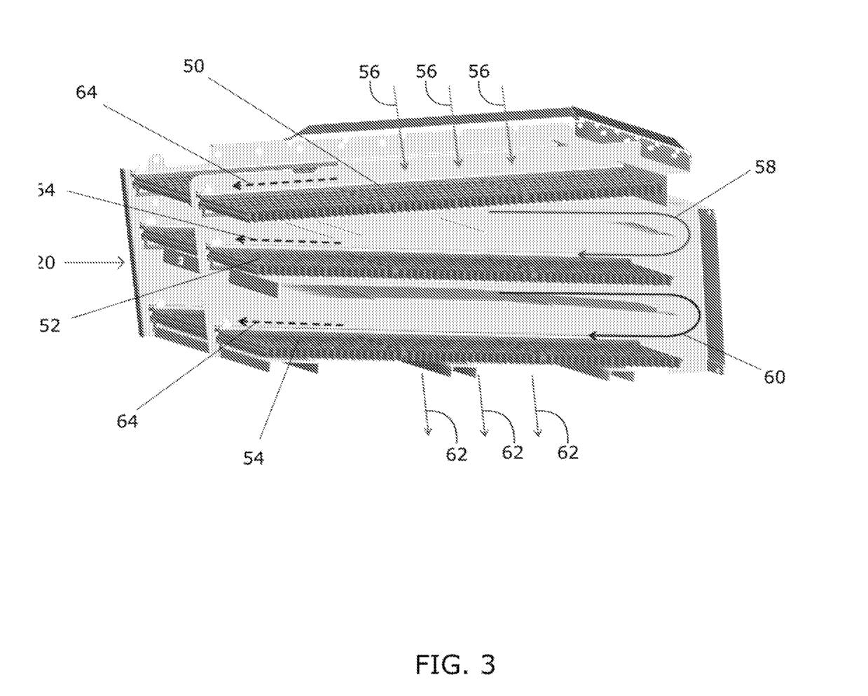

As shown in FIG. 3, a perspective cross-sectional view of a series shaker or recovery shaker 20 is generally shown. Each of the series shakers 20, 22, 24 may be substantially identical to that shown and described with reference to the description of the series shaker 20 shown in FIG. 3. In an embodiment, the series shaker 20 or a plurality of serial shakers make up the second line 12. It should be understood that the parallel shakers 14, 16, 18 may be configured as the second line 12, and the series shakers 20, 22, 24 may be configured as the first line 10. In addition, in other embodiments and/or applications, series shakers and/or parallel shakers may be provided in either or both lines.

The series shaker 20 has a primary scalping deck 50 that receives the entirety of the flow of the series shaker 20. Unlike the parallel shaker 14, the flow may not be divided in the series shaker 20 with the entirety of the flow traveling to a middle deck 52, and the entirety of the flow also traveling to a third deck 54. The incoming fluid is generally designated by arrows 56 at the top portion of the series shaker 20. Scalping effluent to the middle deck 52 is generally shown by arrow 58, and effluent from the middle deck 52 to the third deck 54 is generally shown by arrow 60. The third deck 54 discards effluent to a skid (not shown) as generally shown by arrows 62. Solids are discarded from each of the scalping deck 50, the middle deck 52 and the third deck 54 as generally illustrated by arrows 64. Using the series shaker 20, each of the scalping deck 50, the middle deck 52 and the third deck 54 encounters and/or receives an entirety of the flow to the series shaker 20.

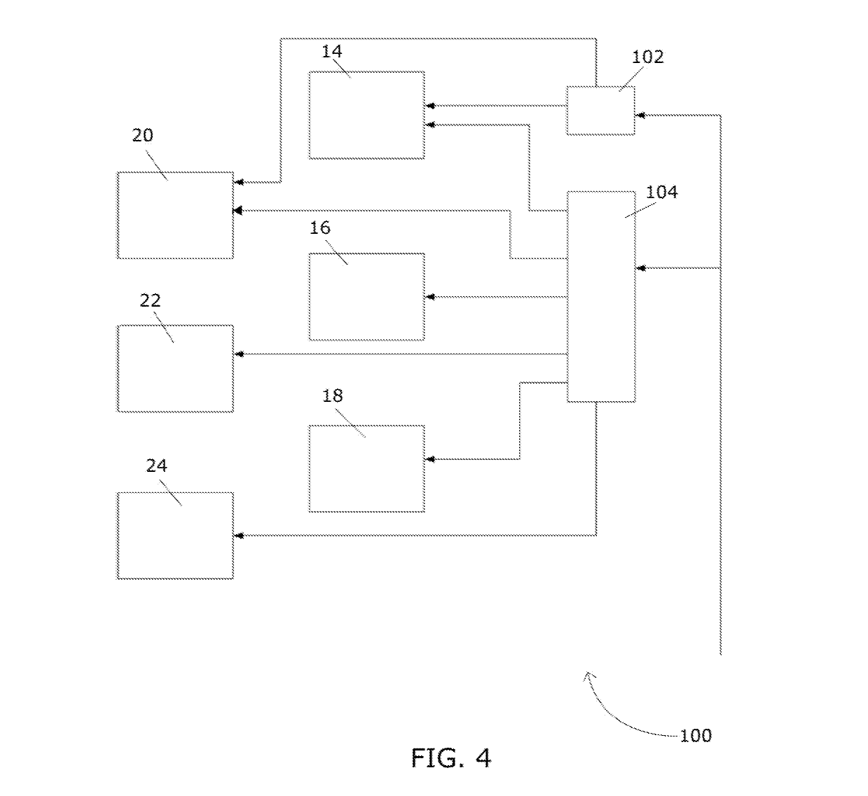

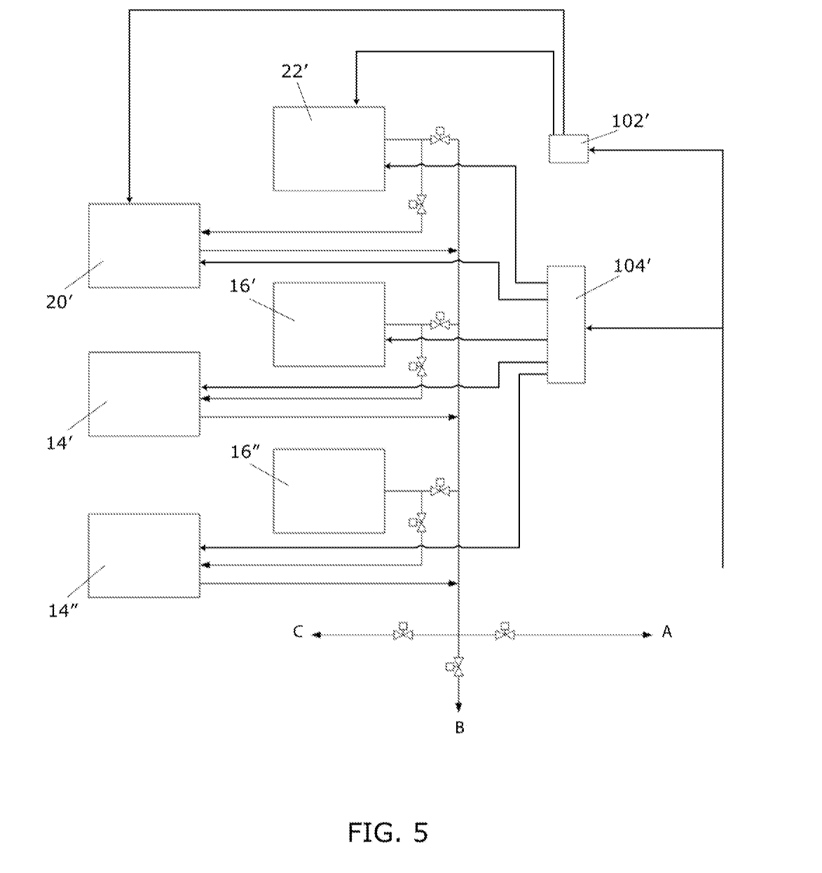

Referring to FIG. 4, a diagram 100 is shown illustrating efficiency of design by implementing the parallel shakers 14, 16, 18 with the series shakers 20, 22, 24. A header box 102 and/or a header box 104 may receive fluid which may be fed to the three parallel shakers 14, 16, 18 and the three series shakers 20, 22, 24. In upper hole sections, all six shakers may receive the fluids at high flow rates. As drilling gets deeper, the hole gets smaller, as generally illustrated by the diagram shown in FIG. 5. As this occurs, the series shakers 20′, 22′ may be isolated. The screens under the series shakers 20′, 22′ may be fed from the parallel shakers 14′, 16′ and/or the parallel shakers 14″, 16″ to the series shakers 20′, 22′. As a result, enhanced and/or finer screening results from the dual pass, multi-level shakers. A header box 102′ and/or a header box 104′ may receive the slurry which may be fed to the three parallel shakers 14, 16, 18 and the three series shakers 20, 22, 24. As shown in FIG. 5, the header box 102′ and the header box 104′ may receive different slurries. The different slurries may originate from different sources, for example, the slurries may be from different wellbores. The different slurries may be processed by the shaker system 1 simultaneously or at different times. The different slurries may also be processed by the shaker system 1 in different flow routes through the shaker system 1 as desired and/or as required due to capacity, for example.

As shown in FIG. 5, outputs of the shakers may be directed to various locations. For example, the outputs may be directed to active separation equipment (not shown) as indicted by arrow A. Also, outputs may be directed to a sand trap (not shown) as indicted by arrow B. Further, outputs may be directed to a shaker pit (not shown) as indicted by arrow C.

Moreover, in some instances, holes may be formed in screening decks of the parallel shakers 14′, 16′, 14″, 16″ and/or the series shakers 20′, 22′. The layout and/or design of the dual pass, multi-level shakers protect an end user from the disadvantageous results of holes formed in any of the screening decks of the parallel shakers 14′, 16′, 14″, 16″ or the series shakers 20′, 22′ that muds and/or solids must pass through during operation of the system.

As a result of the layout and/or configuration of the series shakers and the parallel shakers, a maximum screen surface area may be applied to the flow line. Moreover, screening up and/or as screening as fine as possible may result from the layout and/or configuration of the series shakers and/or the parallel shakers. The stacked design of the series shakers and/or the parallel shakers may provide a first line of defense against drilled cuttings that remain in the drill fluid. The stacked design may result in a single pass of the fluid over the parallel shakers and a single pass over the series shakers. This resultant dual pass stacked shaker system may offer maximum screen area exposure by both sets of the shakers in any single pass. In an embodiment, the screen area exposure to the fluid may be approximately 11.8 m² in any single pass in the stacked system of the parallel shakers in a single pass followed by a single pass over the series shakers.

Thus, in one aspect, embodiments disclosed herein relate to a dual pass shaker with multiple lines having screens. The shakers may be parallel shakers, series shakers, or a combination of one or more parallel shakers and/or one or more series shakers.

In another aspect, a dual pass or stacked shaker and methods are provided by arranging for a dual pass of the fluid passing through the shaker and optimization of screen area of the flow through the stacked shaker. The stacked shaker may provide a single pass over a parallel shaker and a single pass over a series shaker to provide screen area optimization and/or exposure to the fluid in a single pass.

In an aspect, a method has the steps of delivering a slurry having solids and fluids to a series shaker having a first screen; flowing the slurry over the first screen in the series shaker; conveying the slurry from the series shaker to a parallel shaker having a second screen; and flowing the slurry over the second screen in the parallel shaker.

It should be understood that various changes and modifications to the presently preferred embodiments described herein will be apparent to those skilled in the art. Such changes and modifications may be made without departing from the spirit and scope of the disclosure and without diminishing its attendant advantages. It is, therefore, intended that such changes and modifications be covered by the appended claims.

1. A method comprising:
providing a first shaker having a screen arranged between an input and an output wherein the input is configured to receive a slurry;
providing a plurality of shakers interconnected to one another wherein each of the shakers has a screen arranged between an input and an output;
connecting a distribution manifold between the output of the first shaker and the inputs of the plurality of shakers; and
controlling a flow of the slurry via the distribution manifold from the first shaker to a selected shaker of the plurality of shakers.

2. The method of claim 1 further comprising:
bypassing at least one of the plurality of shakers using the distribution manifold.

3. The method of claim 1 further comprising:
controlling the flow of the slurry via the distribution manifold based upon fluid properties of the slurry.

4. The method of claim 1 further comprising:
controlling the flow of the slurry via the distribution manifold based upon the composition of the slurry after passing through selected shakers.

5. The method of claim 1 further comprising:
controlling the flow of the slurry via the distribution manifold based upon flow parameters of the shakers.

6. The method of claim 1 wherein the shakers have different screening configurations.

7. The method of claim 1 further comprising:
switching a flow of the slurry from one shaker to another via the distribution manifold.

8. The method of claim 1 further comprising:
directing the slurry from the first shaker to multiple shakers simultaneously via the distribution manifold.

9. The method of claim 1 further comprising:
delivering a first portion of the slurry to a plurality of series shakers wherein each series shaker has a first plurality of screens wherein the slurry passes over the first plurality of screens in each series shaker wherein the plurality of series shakers are connected to a plurality of parallel shakers wherein the slurry from each series shaker is conveyed to the corresponding parallel shaker wherein each parallel shaker has a second plurality of screens wherein a portion of the slurry flows over each of the second plurality of screens in the parallel shaker.

10. The method of claim 1 further comprising:
monitoring parameters of the slurry in the shakers.

11. The method of claim 1 further comprising:
customizing a flow of the slurry through the shakers to maximize the number of screens over which the slurry flows.

12. A system comprising:
a first shaker having screens wherein a slurry flows over the screens in succession;
a second shaker having screens wherein a portion of the slurry flows over the screens wherein the second shaker is different than the first shaker;
a third shaker having screens; and
a distribution manifold connected to an output of the first shaker and connected to an input of the second shaker and further connected to an input of the third shaker wherein the distribution manifold controls a flow of the slurry from the first shaker.

13. The system of claim 12 wherein the distribution manifold has an interconnected network of pipes having valves wherein the valves control flow of the slurry through the pipes to selected shakers.

14. The system of claim 12 further comprising:
a first header box having an input and an output wherein a first slurry is delivered to the input of the first header box and the first slurry is conveyed from the output of the first header box to the shakers and a second header box having an input and an output wherein a second slurry is delivered to the input of the second header box and the second slurry is conveyed from the output of the second header box to the shakers wherein the first slurry originates from a separate source than the second slurry and further wherein the first slurry and the second slurry are conveyed to the shakers simultaneously.

15. A method comprising:
providing a first plurality of shakers to separate fluids and solids from a slurry;
providing a second plurality of shakers to separate fluids and solids from the slurry; and
connecting the first plurality of shakers to the second plurality of shakers using a manifold wherein the manifold controls flow of the slurry between the first plurality of shakers and the second plurality of shakers.

16. The method of claim 15 further comprising:
arranging the first plurality of shakers in a position above the second plurality of shakers wherein the slurry flows from the first plurality of shakers to the second plurality of shakers.

17. The method of claim 15 further comprising:
changing the flow of the slurry instantaneously by using the manifold.

18. The method of claim 15 further comprising:
connecting pipes and valves between the manifold and the shakers wherein the valves control flow of the slurry through the pipes to selected shakers.

19. The method of claim 15 further comprising:
controlling the flow of the slurry to select shakers to maximize screening of the slurry.

20. The method of claim 15 further comprising:
correlating the flow of the slurry to parameters associated with the shakers.
